(19) United States
(12) Patent Application Publication
(10) Pub. No.: US 2010/0092636 A1
(43) Pub. Date: Apr. 15, 2010

(54) ULTRAFAST METHOD FOR CREATING AGED WOOD FLAVORED ALCOHOLIC BEVERAGES

(75) Inventors: Daniel Martin Watson, Driftwood, TX (US); Billie Sunday Watson, Wimberley, TX (US)

Correspondence Address: BUSKOP LAW GROUP, P.C., 4511 Dacoma Street, HOUSTON, TX, 77092, US

(73) Assignee: Daniel Martin Watson, Driftwood, TX (US)

(21) Appl. No.: 12/248,603

(22) Filed: Oct. 9, 2008

(51) Int. Cl. C12H 1/00; C12G 3/00

(52) U.S. Cl. 426/533; 426/442

(57) ABSTRACT

A method of creating an aged, ethanol-containing beverage using pressure for distinct periods of time of less than 3 months and at least one wood piece to create a wood flavored alcoholic beverage similar to beverages aged 10 to 30 years without losing any volume of product during the method.

### FIELD

The present embodiments relate to a method of creating very quickly, an aged, wood flavored, ethanol-containing beverage.

### BACKGROUND

A need exists for a homogenously wood flavored ethanol-containing beverage that possesses improved uniform wood flavor and can be aged in a very short period of time, this enables a distiller to sell more product as up to 60 percent of the product evaporates during slow aging, particularly for whiskies over more than 10 years. A need exists for a method of creating ethanol-containing beverages with a wide variety of wood flavors, each having a very smooth drinkability inexpensively, in less than two weeks, with a taste of between 10 and 35 years of aging.

The present embodiments meet these needs.

### DETAILED DESCRIPTION OF THE EMBODIMENTS

Before explaining the present embodiments in detail, it is to be understood that the embodiments are not limited to the particular embodiments and that they can be practiced or carried out in various ways.

The present embodiments relate to a method of creating an aged, collectable ethanol-containing beverage that is ultra-fast, aging the beverage in less than 3 months to create a flavor and smoothness of a product aged 10 to 30 years.

The manufacturing method begins by selecting one or more wood pieces useful in imparting one or more wood flavor components to an ethanol-containing beverage.

The selected one or more wood pieces are inserted into a pressurizable container holding an ethanol-containing beverage.

The ethanol-containing beverage is then aged at either one continuous positive pressure, above atmosphere, ranging from 15 psi to 5000 psi or aged using a combination of positive pressure in a cyclical manner for short periods of time, wherein the total time used for aging does not exceed 3 months. This aging process enables a distiller to make and sell between 10 percent and 40 percent more product, as during traditional aging a substantial amount of product is lost to evaporation in order to gain the simultaneous combination of flavor and smoothness.

In still another embodiment of the invention, the beverage containing ethanol with wood pieces can be aged using positive and negative pressures in a cyclical manner for a short period of time ranging from 1 hour to no more than 3 months in a pressurized container. One or more wood pieces can be used in this method. The combinations of different pressures, different times, and different wood pieces can be used varied to create beverages with different smoothness in the aging process, different flavor intensities, and different blendings of flavor while maximizing the amount of product being produced by the distiller.

In particular, for beverages for humans containing between 30 percent and 96 percent alcohol, such as grain spirits, whiskey, brandy, rum, vodka, cachaca, eau de view, grappa and others, experimental results have shown that for treating the liquid with wood at pressures of 15-60 psi for 3 months yields a result that tastes like 10 to 30 year aged beverage with intense wood flavor.

The method herein can be used for wine and beer with a lower alcohol contents such as 6 percent to 12 percent alcohol for imparting an oak flavor so popular with dark red wines, for example. Additionally after dinner drinks, like liquors can be wood flavored by this method as well, and liquors traditionally have between 15 percent to 40 percent alcohol. Wine can be aged with this method using only a few hours at a medium pressure of 100-200 psi.

For pressures of 500 psi to 1000 psi for 2 weeks, a beverage with 50 percent ethanol can be aged with oak and produce a drink that tastes like a beverage aged 10 to 30 years. Rum drinks work very well at 500 to 1000 psi for 2 weeks with pecan wood to create a smooth beverage.

This process has resulted in bottles of alcoholic flavored beverages that have won numerous awards some of those awards include:

Rums, made using these technologies to age, flavor, and/or smooth, have been entered in several competitions and have received awards. At the 2008 International Rum Festival, Temptryst Reserve Rum, made using this technology with a blend of woods, won the both a gold medal and the “Best of Category” award in the dark rum category. In the same event, both Temptryst Sugarcane Matured Rum and Temptryst Lemon Wood Rum won gold medals in the dark rum category. Temptryst Peachwood Rum won a silver medal. In the 9-15 Year Aged Category, Temptryst Applewood Rum and Temptryst Hickory Rum won gold medals while Temptryst Live Oak Rum won silver and Temptryst Coconut Wood Rum won bronze. In the +15 Year Aged Category Temptryst Cherrywood VSO won a silver medal. In the white rum category Temptryst Light Dew Rum won a bronze. There were approximately 150 of the finest rums in the world in this competition. At the prestigious 2007 Ministry of Rum Tasting Competition, 3 gold medals, and 4 silver medals were won using a variety of the lower pressures and longer times described herein. At the 2008 Ministry of Rum Tasting Competition, approximately half of the gold medals won in the Dark, Aged, and Premium Categories were won by rums made using a variety of the highest pressures and shortest times described herein. Medals awarded to this group of rums were 7 gold, 4 silver, and 1 bronze.

In another example, rum was inserted in a 12 liter pressurized container, and treated at a constant pressures using pressurized air of 1000 psi to 2000 psi for 1 week. the results yielded an award winning rum similar to a rum having been aged 10 to 30 years.

Other rums and whiskeys were pressure treated in the same pressurized container, which for all these experiments was a stainless steel scuba tank capable of holding 12 liters of liquid and supporting safely, pressures of 2000 psi to 2500 psi, for many days. In an experiment of whiskey treated to 2000 psi for three days, a smooth drinkable whiskey with the flavor of oak was produced using oak powder. The pressure applied was compressed air. The rum and whiskey so treated produced a results are similar to 10 to 30 years of aging.

In another experiment, rum was treated at a pressure of 2500 psi to 3000 psi for 1 day using cherry wood chips, for one run, another run used pecan wood sticks, and a third run used maple wood planks. In each case, in the 12 liter scuba tank, the results yielded an alcoholic beverage is similar to 10 to 30 years of aging.

Lower pressures may work to produced an aged beverage, such as using pressures of only 16 psi to 60 psi for 3 months could make a white rum into a big dark rum.

Similarly, a white rum, can be treated with oak at 60 psi for 1 day to not change the color, but to just mellow the taste, taking the edge off the beverage.

The method creates an aged beverage at a lower price than conventional aging, because conventional aging looses between 2-10 percent of the beverage during the aging process per annum during the aging process. 10 years of aging typically yields only 40 percent of the beverage, loosing 60 percent of the beverage during the multiyear aging process This method enables the distiller to sell more smooth yummy product.

Additionally this method enables a distiller to create a lighter wood flavoring in the alcohol using any pressure and time, such as 1 hour at 3000 psi. Many variables are usable in this process.

In an alternative embodiment, by raising or lowering pressure, the alcohol is moved in and out of the wood, so that using variable pressures, that is, by cycling pressure, the same results can be achieved in a shorter time than by continuous pressure systems.

For example, a cycling of pressure could be as follows, a rum could be mixed with pecan and pressurized to 3000 psi for 2 hours, then the pressure can be dropped to 500 psi and held at the lowered temperature for 1 hour, then the pressure is raised again to 3000 psi for 1 hour and then released to atmospheric pressure to produce a delicious aged rum with the wood flavors of pecans.

Another variation of this method contemplates having a whiskey mixed with oak and then pressurized to 3000 psi for 1 hour, then dropped to a slight vacuum, such as −50 psi for 0.5 hour, and then raised again to 3000 psi for 3 hour, then released to atmospheric pressure.

Though it is contemplated that in the cycling process that the first and last pressures are identical, the invention can be used wherein the first and third starting pressures are different, the concept of cycling the pressures is to move the alcohol in an out of the wood.

A pressurized container with a very small volume of air may be preferred for economy of energy. Pressurizable containers with greater percentages of air lead to greater speeds of chemical interaction amongst the vapors, which creates significantly richer aroma.

Temperatures, such as heating and cooling can be added to the outside of the pressurized container to heat or cool the product quickly and for controlled amounts of time. The air used to pressurize the container may also be heated for faster reaction times or chilled for greater safety with fast pressurization.

It is contemplated that initially, all the pressurizations can be at room temperature, or ambient temperatures. In an embodiment heating elements can be inserted into the pressurized container and used to increase the contents of the pressurizable container without heating the walls, and thereby saving money in the manufacturing process.

By keeping the alcohol under pressure, the boiling point is raised. The heating should not be so high as to burn the wood chips, and not exceed 280 degrees Fahrenheit as that would spoil the wood flavor and would create problems and “ashy” taste when the temperature is too hot.

The method contemplates to create a concentrate of spirits, using high contents of wood and high content ethanol to create a “wood flavor alcohol concentrate” that then can be added to a beverage to create the wood flavored drink.

The amount of wood to alcohol, can range from 5 grams of wood to 100 grams of wood per liter of liquid having 40 percent alcohol content.

The wood chips can be in various shapes, slabs, powders, in a bag with perforations, in a net, in another container, or another other container having at least one opening. It is possible that a container with a cellulose membrane filter that allows two way movement of liquid would work as well.

2000 gallon tanks can be used to accommodate 6000 psi with manhole side covers that could be filled, and stainless steel bucket full of wood chips can be used in the pressurization to add wood flavor.

Heat can be added to the pressurized container internally rather than externally to the container, to increase the wood flavor saturation of the wood chips into the alcohol. This temperature imparted in this manner is referred to herein as “light heat” for “short time periods.”

In an embodiment, it is contemplated that the pressurizable container can be agitated, at intervals, or agitated slowly or continuously to improve wood flavor dissemination. It is also contemplated that the liquid could be stirred, such as with paddles or intermittently stirred to create good blending, particularly at lower pressures.

The agitation should be just enough to create mixing without adding excessive air into the alcohol. It is desired to have only 3 percent to 20 percent airspace to prevent undesirable chemical interaction.

The characteristics of the continuously aging, collectable ethanol-containing beverage with improved wood flavor can be selectively manipulated through changing the pressure, and length of time for which the ethanol-containing beverage is permitted to age. The speed of the aging process can also be increased through selectively manipulating the pressure and the duration of the pressure at which the ethanol-containing beverage and the one or more wood pieces are permitted to age.

The characteristics of the continuously aging, collectable ethanol-containing beverage with improved wood flavor can also be manipulated through the type of wood selected, the type of ethanol-containing beverage selected, the preparation and form of the wood, and the use of additional wood flavorings.

The wood pieces can be any type of wood, including but not limited to oak, maple, hickory, mesquite, cherry, apple, pecan, alder, guava, almond, peach, apricot, acacia, ash, birch, cottonwood, lemon, lilac, mulberry, nectarine, orange, pear, plum, walnut, cedar, pine, grapefruit, lime, chestnut, sycamore, and combinations thereof.

The wood pieces can also be one or more pieces of bark, one or more whole nut shells, one or more pieces of nut shell, one or more pieces of coconut shell, one or more nuts, and combinations thereof. Nuts or nut shells could include peanuts, pecans, walnuts, chestnuts, cocoa nuts, other nuts, and combinations thereof.

The one or more selected wood pieces can have any form, including powder, sticks, chunks, chips, or combinations thereof. It is also contemplated that the wood pieces could be provided with a distinct shape, such as fish, stars, one or more individuals' names, a worm shape, a geometrical shape, and other shapes. The one or more wood pieces can be sized such that they are able to fit through an opening in the pressurizable container.

The ethanol-containing beverage can be any ethanol-containing beverage including but not limited to a whiskey, a bourbon, a rum, a brandy, a vodka, a tequila, and an eau de vie.

In an embodiment the one or more selected wood pieces can be roasted prior to associating the wood pieces with the ethanol-containing beverage. This can be beneficial due to the fact that the aging process is slower when raw wood is used.

It is also contemplated that the one or more wood pieces can be roasted wood, charred wood, dehydrated wood, dried wood, raw wood, or combinations thereof.

The roasting of the selected one or more wood pieces can be performed by flash roasting. The flash roasting can have a flame temperature in excess of 2000 degrees Fahrenheit.

The roasting can also be performed for up to eight hours at a temperature ranging from about 180 degrees Fahrenheit to about 220 degrees Fahrenheit. In other embodiments, the roasting can be performed at about 380 degrees Fahrenheit for a time period ranging from about two hours to about four hours, or at a temperature of about 460 degrees Fahrenheit for a time period ranging from about one half hour to about one hour.

The one or more selected wood pieces can also comprise additional wood flavoring, such as vegetable oils, nut oils, fruit extracts, vegetable extracts, spices, or other wood flavorings disposed therein.

In an embodiment, the method can further comprise the addition of a small amount of a fruit, a vegetable, a flower, a herb, a spice, or combinations thereof. The fruit, the vegetable, the flower, the herb, the spice, or any combination thereof can be roasted, dehydrated, fresh, dried, or combinations thereof.

The present embodiments also relate to a beverage produced using the embodied method.

The beverage comprises an ethanol-containing beverage, such as a whiskey, a bourbon, a rum, a brandy, an Armagnac, a cognac, a vodka, a tequila, or an eau de vie, that has been permitted to age in the container, with one or more selected wood pieces.

Due to the wide variety of ethanol-containing beverages, types of wood, wood preparation methods, and additional wood flavorings that can be used, an entire series of collectable, continuously-aging marketing tools that increase in value as time passes can be created and collected.

Select wood pieces can also be used, such as uniquely shaped wood pieces, or uniquely sized wood pieces able to fit through an opening in the pressurizable container. Select corks, stoppers, labels, and other items can be used to further enhance the appearance and commercial appeal of the continuously-aging, collectable ethanol-containing beverage with improved wood flavor.

While these embodiments have been described with emphasis on the embodiments, it should be understood that within the scope of the appended claims, the embodiments might be practiced other than as specifically described herein.

1. A method for rapidly aging while flavoring an ethanol-containing beverage to form a smooth alcoholic beverage, comprising the steps of:
(a) selecting at least one wood piece useful in imparting at least one wood flavor to an ethanol-containing beverage;
(b) inserting the at least one wood piece in a pressurizable container adapted for holding between 1 gallon and 6000 gallons of liquid with less than 1 gallon of airspace;
(c) adding a liquid containing between 3 percent and 96 percent ethanol into the pressurizable container; and
(d) applying a first pneumatic pressure of between 15 psi and 6000 psi to the liquid in the pressurizable container for a first time period of less than 3 months to push the ethanol through the wood and simultaneously age and flavor the ethanol in the pressurizable container quickly aging the ethanol-containing beverage with the at least one wood flavor component to a smoothness comparable to barrel aged alcoholic beverage.

2. The method of claim 1, further comprising the step of applying a second pneumatic pressure of between 15 psi and 5000 psi, wherein the second pneumatic pressure is different from the first pneumatic pressure for a second time period wherein the combination of the first and second time periods does not exceed 3 months to quickly age the ethanol-containing beverage with the at least one wood flavor component to a smoothness comparable to a 10 to 30 year aged alcoholic beverage.

3. The method of claim 2, further comprising the step of applying a third pneumatic pressure of between 15 psi and 5000 psi, wherein the third pneumatic pressure is different from the second pneumatic pressure for a third time period and wherein the combination of the first, second and third time periods does not exceed 3 months to quickly age the ethanol-containing beverage with the at least one wood flavor component to a smoothness comparable to a 10 to 30 year aged alcoholic beverage.

4. The method of claim 2, further comprising cycling the first and second pressures in sequence for at least three cycles of first, second as cycle 1, first second as cycle 2 and first second as cycle three for a time period not to exceed 3 months quickly aging the ethanol-containing beverage with the at least one wood flavor component.

5. The method of claim 1, wherein the ethanol-containing beverage is selected from the group consisting of: a grain spirit, a whiskey, a whisky, a bourbon, a rum, a cachaca, a brandy, an Armagnac, a cognac, a vodka, a tequila, a mescal, a wine, an ale, a beer, an eau de vie.

6. The method of claim 1, wherein the at least one wood piece is selected from the group consisting of: ash, birch, crabapple, grapevine, grapefruit, lime, pear, bay, carrotwood, kiawe, madrone, beech, butternut, fig, gum, chestnut, hackberry, willow, mulberry, lilac, maple, orange, sugarcane, nectarine, peach, eucalyptus, bois bande, cashew, alder, algerita, persimmon, acacia, cherry, mesquite, oak, hickory, apple, pecan, coconut, lemon, manzanita, pimento, manuka, guava, almond, brazilnut, apricot, plum, olive, walnut, amburana, jesuitical and combinations thereof.

7. The method of claim 1, wherein the percentage of ethanol is between 35 percent and 80 percent.

8. The method of claim 1, wherein the at least one wood piece comprises a member of the group: roasted wood, charred wood, dehydrated wood, dried wood, raw wood, or combinations thereof.

9. The method of claim 8, wherein charcoal is added or the roasting of the at least one wood piece is flash roasting.

10. The method of claim 6 wherein the at least one wood piece is in the form of powder, sticks, chunks, chips, or combinations thereof.

11. The method of claim 1, wherein the at least one wood piece comprises a member of the group: at least one piece of bark, at least one whole nut shell, at least one piece of nut shell, at least one piece of coconut shell, at least one nut, and combinations thereof.

12. The method of claim 1, further comprising inserting into the pressurizable a small amount of: a fruit, a vegetable, a flower, a herb, a spice, or combinations thereof.

13. The method of claim 12, wherein the fruit, the vegetable, the flower, the herb, the spice, or combinations thereof is roasted, dehydrated, fresh, dried, or combinations thereof.

14. The method of claim 2, wherein the second pressure is a negative pressure of between 0 psi and −50 psi.

15. The method of claim 2, wherein the second time period is identical to the first time period.

16. A continuously-aging, ethanol-containing beverage made by the method of claim 1.

17. A continuously-aging, ethanol-containing beverage made by the method of claim 2.

18. A continuously-aging, ethanol-containing beverage made by the method of claim 3.

19. A continuously-aging, ethanol-containing beverage made by the method of claim 4.

20. The method of claim 1, further comprising agitating or stirring the liquid during pressurization.
